(19) United States
(12) Patent Application Publication
(10) Pub. No.: US 2001/0012554 A1
(43) Pub. Date: Aug. 9, 2001

(54) Energy-absorbing component and method of producing the same

(75) Inventors: Reinhard Wirobski, Marl (DE); Bernd Guenzel, Haltern (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: HUELS AKTIENGESELLSCHAFT

(21) Appl. No.: 09/739,208

(22) Filed: Dec. 19, 2000

Related U.S. Application Data
(63) Continuation of application No. 08/950,293, filed on Oct. 14, 1997.

(30) Foreign Application Priority Data
Oct. 11, 1996 (DE) 196 41 944.1

(51) Int. Cl. B32B 3/26; B29C 44/06

(52) U.S. Cl. 428/120; 264/45.4; 264/112

(57) ABSTRACT

An element for the absorption of energy which contains reinforcing elements which extend at least partially in the direction of compression to which the element is subjected, wherein the reinforcing elements within the element are encircled by plastic foam particles glued or welded to one another, said reinforcing elements at least partially taking up the compressive force whereby they buckle in on overshoot of a compression of at most 20% with respect to their length in the direction of compression.

### CROSS-REFERENCE TO RELATED APPLICATIONS

This application is a continuation application of Continued Prosecution Application (CPA) U.S. Ser. No. 08/950,293 filed May 12, 2000 which is a continuation of application U.S. Ser. No. 08/950,293 filed Oct. 14, 1997.

### BACKGROUND OF THE INVENTION

1. Field of the Invention

The present invention relates to a component for the absorption of energy which contains a polyolefinic particle foamed plastic core wherein in addition reinforcing elements are foamed around that are oriented in the direction of the load, as well as to a process for its production.

2. Description of the Background

Energy-absorbing elements are used in particular in the structure of motor vehicles in order to receive a large part of the kinetic energy of impact, and thus to increase the safety of the occupants. Prior-art applications are shock absorbers, side doors, and impact deflector elements which are used for the support of the bumpers with respect io the supporting body structure. The energy-absorbing elements can be produced therein from the most vaned of materials.

The DE 43 27 022 describes a multi-layer structure with spacing textiles and reinforcing fibers of glass, carbon fibers, or plastic.

EP 0 097 504 and EP 0 155 558 describe a bumper application that uses expanded polypropylene as the energy-absorbing part in the core element.

In EP 0 401 838 an energy-absorbing composite material is described which is produced of breakable hollow balls and particle foam.

Additional energy-absorbing components are described in EP 0 055 364, DE 37 23 681, and DE 21 58 086.

It is common to all these embodiments that they are expensive to produce or that at the beginning of deformation initially only a small amount of energy is absorbed.

The yield factor can be drawn upon for the characterization of an energy-absorbing element. This gives the ratio of the total surface under the load curve to that under the rectangular curve of the ideal energy absorber in the force-path diagram. The maximal energy can be absorbed by an element only if as vertical a deformation free rise in force as possible up to a certain maximum force, and a subsequent constant uptake of force up to a maximum deformation would be realizable. This would correspond to a rectangular stress-compression curve and thus to an ideal energy absorber. Energy-absorbing elements of polyolefin foam do not satisfy the requirements of an ideal absorber. In the case of polypropylene foam (EPP), the yield factor in quasi-static measurements is only in the range of 0.60 to 0.65.

### SUMMARY OF THE INVENTION

Accordingly, one object of the present invention is to provide an energy-absorbing element on the basis of polyolefin foam in which the yield factor can be clearly increased, and in which, even at the beginning of deformation, the energy absorption is high.

Briefly, this object and other objects of the present invention as hereinafter will become more readily apparent can be attained by an element for the absorption of energy which contains reinforcing elements which extend at least partially in the direction of compression to which the element is subjected, wherein the reinforcing elements within the element are encircled by plastic foam particles glued or welded to one another, said reinforcing elements at least partially taking up the compressive force whereby they buckle in on overshoot of a compression of at most 20% with respect to their length in the direction of compression.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a representation of an energy-absorbing element in accordance with the present invention showing body (1), apertures (2), reinforcing elements (3) and (4) and the direction of applied compression (5); and

FIG. 2 is a graph with maxima (3′) and (4′) showing the load curves in the graph of force against displacement for an energy-absorbing element in accordance with the present invention compared to a non-reinforced polypropylene core.

### DETAILED DESCRIPTION OF THE PREFERRED EMBODIMENTS

Surprisingly, the objective of the present invention can be realized by an energy-absorbing element which contains(reinforcing) elements which are formed around a polyolefin where the reinforcing elements are affixed to a carrier. Preferably, the reinforcing elements form a common part with the carrier, for example, an injection-formed part. That is, the reinforcing elements are multiply produced together in one form. The reinforcing elements are connected to one another by material bridges. The material bridges result from the fact that the injected material flows from one cavity to another via channels. This is a prior-art type of production. It is different and novel that the connecting material bridges are not removed for the use of the reinforcing elements, but rather remain and, moreover, reach such dimensions that they hold the reinforcing elements when the reinforcing elements are positioned for foaming behind in another form. The entire arrangement is laid into a form tool and foamed behind with particle foam. Particle foam is formed by small foam particles (beads). The foam particles are, for example, introduced into the form with compressed air whereby the compressed air is given opportunity to escape from small apertures in the wall of the form. Subsequently, the plastic foam particles are connected to one another in the form by gluing or welding. The connection is done preferably by pressurizing with superheated steam. The superheated steam melts the surface of the particle foams and pressure is generated. Under pressure, the melted foam surfaces connect to one another. In the case of pressurization with superheated steam, the expansion associated with the heating of the particles is as a rule sufficient to generate the necessary pressure.

From EP 0 254 530 a core material for automobile shock absorbers is known which contains indentations in which reinforcing elements of compact material fit. The depth of the indentations is preferably 15-95% of the thickness of the core material. It has been shown that the insertion of the reinforcing elements into the foam core must be done very carefully in order not to damage the core or the reinforcing elements. For this reason the reinforcing elements are built more compactly than absolutely necessary which leads to unnecessarily high total weight. Moreover, the energy absorption is not high enough when the reinforcing elements do not extend over the entire thickness of the core.

In the case of the present invention any plastic with sufficient rigidity can be used for the reinforcing elements, for example let polyolefins such as polypropylene, polyamides such as polyamide-6, polyamide-66, polyamide-612, polyamide-12, polyesters such as polybutylene terephthalate (as a blend with polycarbonate), liquid crystal aromatic copolyesters, polystyrene, polyphenylene oxide or PVC be noted. To achieve a higher rigidity the reinforcing elements also contain fillers and/or fibers. From the point of view of recycling, a polypropylene is preferably used.

The production of polyolefin particle foam is, for example, known from EP 0 053 333 and EP 0 095 109. In the scope of the invention any prior-art polyolefin foam can be used, for example, of a polyethylene of high, average, or low density, a polypropylene such as polypropylene homopolymerizate, ethylene-propylene block copolymers, blends of polypropylene with ethylene vinyl acetate copolymers, and preferably ethylene propylene butene-(1)-terpolymers or ethylene propylene random copolymers.

Preferably ethylene propylene butene-(1) random terpolymers with 1 to 15 wt. % ethylene and 1 to 10 wt. % butene-(1) or ethylene-propylene random copolymers with 1 to 15 wt. % ethene, and in particular with 2 to 5 wt. % ethene, are used.

Preferably particle foam with packing densities of 12 to 80 wt. % are used. Form parts result therefrom with weights per unit space of 15 to 170 g/L and in particular of 25 to 100 g/L.

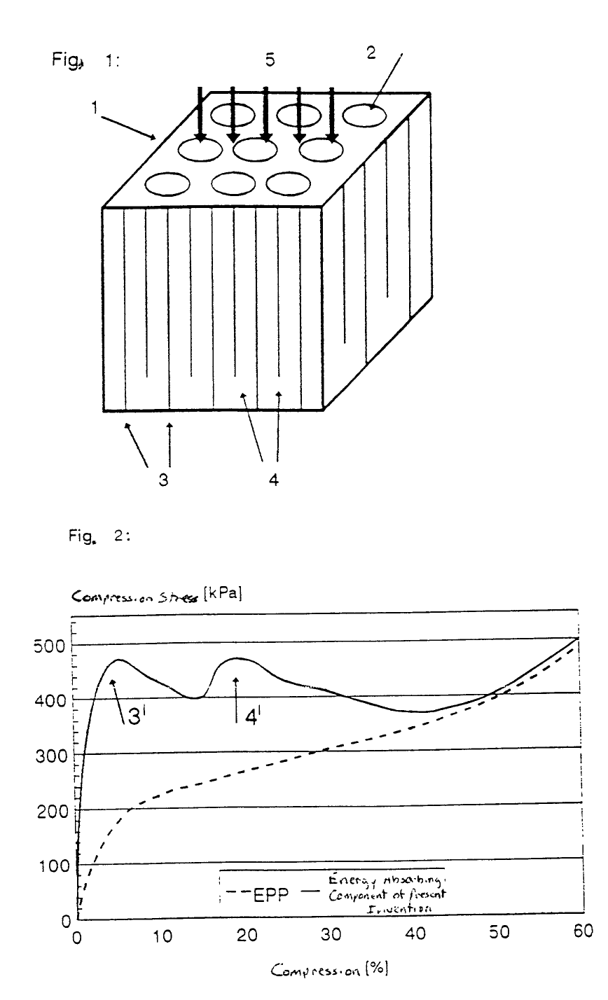

FIG. 1 shows the schematic structure of an element for the energy absorption in a cubical extract. If one takes as an example a shock absorber or a side door, then the energy when stressed is spread over the broad surface of the shock absorber jacket or the side door sheet to the element. The energy conducted in is thereby taken up first of all by the reinforcing elements (3), due to the far higher rigidity of the material, that by their form preferably bickle lengthwise with a compression of 2 to 20% in the direction of compression. When formed as a bar, the reinforcing elements (3) possess a length that corresponds to the thickness of the body (1) in the direction of compression.

With the buckling in of the first reinforcing element (3), second reinforcing elements (4) take up the significant compression pressure. The second reinforcing elements (4) have a smaller length than the first reinforcing elements in the direction of compression. The difference in length results from the shortening of the length which the first reinforcing elements experienced on buckling in. At that moment the second reinforcing elements take over the load. The buckling in of the reinforcing element is made more difficult by the foaming around. A part of the energy is received uniformly transverse to the direction of compression of the polyolefin foam. On deformation above ca. 20% the stress of the buckled-in reinforcing elements drops off drastically. After the buckling in of all the reinforcing elements, the encircling plastic foam takes over the absorption of energy. In order to hold the curve of the pressure/deformation curve at a high level of stress after the buckling in of the reinforcements in the sense of the statement of the objective, various reinforcing elements can be disposed next to one another and behind one another so that, after the buckling in of the first reinforcing elements, second reinforcing elements can take up the stress. Beyond the second reinforcing elements, third and fourth and additional reinforcing elements can be provided such that a functional chain of reinforcing elements is formed.

The reinforcing elements are disposed longitudinally along the direction of deformation (5). Deviating therefrom the supporting elements can also be disposed entirely or partially at an arbitrary angle to the direction of deformation in order to receive laterally occurring forces.

The form of the reinforcing elements can be of the most varied structure and strength (massive rods, thin tubes, discs, crosses, Y-, X-, T-, L-, U-, and Z-profiles, etc.). For convenient handling the reinforcing elements are injection molded together. The common injection-molding causes connecting material bridges between the reinforcing elements. These material bridges are chosen so thick and wide that the reinforcing elements are held sufficiently rigid by the material bridges. From the reinforcing elements (3) and the material bridges, a grid construction arises, for example, with reinforcing elements in the form of a bar. The entire arrangement is laid into a form tool and foamed behind according to the prior art. By suitable strength, form, number, and length of the supporting elements per unit area, the characteristics of the force-path curve can be favorably influenced in such a way that a yield factor of 0.8-0.95 can be achieved.

FIG. 2 reproduces the curve of the load curves of a polypropylene foam (EPP) core and, produced with the use of EPP, an element for the absorption of energy with two supporting planes (corresponding to FIG. 1) in the force-path diagram. The maxima (3′) and (4′) follow from the load of the respective supporting planes.

Proceeding from this example the application of a third supporting plane at ca. 70% of the length of the component in the direction of compression generates at ca. 30% deformation an additional maximum of the energy absorption. Thereby the yield factor of the system is improved still more.

The measurements for the reception of the force-path are determined according to DIN 53 421. Thereby test bodies with supporting elements and an edge length of 50 mm are compressed between two plane plates with a constant speed of 5 mm/min up to 60% deformation.

The energy-absorbing element, according to the invention, can be used in the automotive field, for example, as shock absorbers, as protection against lateral impact, such as the area of the door, or as an impact-deflecting element. An additional application is found in reusable pallet systems that are repeatedly stacked one over the other. By the introduction of a plane of supporting elements, a high static surface load capacity for long-term load is achieved such that the pallets are not compressed thereby. Only in case of a crash is the described energy absorption achieved by buckling of the supporting elements.

The energy absorbing element of the present invention is prepared by a molding process wherein reinforcing elements are placed in a mold cavity such that the elements extend in the mold in the direction of applied stress to which the product molded element is subjected. Usually the reinforcing are placed in position in the mold by means of a carrier which supports the elements in their proper position in the mold. The elements are then surrounded with plastic foam particles as the mold is filled with the particles. Commonly, the foam particles are passed into the mold in a stream of compressed air. Air is able to escape the mold through small openings in the wall of the mold leaving the foam particles behind. Subsequently, the foam particles are bonded together in the mold cavity by gluing or melting them, and the particles envelop the reinforcing elements. Bonding of the plastic foam particles occurs preferably by applied steam. The hot steam partially melts the surfaces of the foam particles, and a pressure is generated in the mold. The partially melted foam surfaces bond under this pressure. With the application of hot steam, expansion of the particles occurs which is generally sufficient to produce the pressure required for bonding.

The disclosure of German priority Application Number 196 41 944.1 filed Oct. 11, 1996 is hereby incorporated by reference into the present application.

Obviously, numerous modifications and variations of the present invention are possible in light of the above teachings. It is therefore to be understood that within the scope of the appended claims, the invention may be practiced otherwise than as specifically described herein.

What is claimed as new and is intended to be secured by Letters Patent is:

1. An element for the absorption of energy which contains reinforcing elements which extend at least partially in the direction of compression to which the element is subjected, wherein the reinforcing elements within the element are encircled by plastic foam particles glued or welded to one another, said reinforcing elements at least partially taking up the compressive force whereby they buckle in on overshoot of a compression of at most 20% with respect to their length in the direction of compression.

2. The element for the absorption of energy according to claim 1, wherein the reinforcing elements buckle in on overshoot of a compression of at least 2% with respect to their length in the direction of compression.

3. The element for the absorption of energy according to claim 1, wherein the reinforcing elements are not foamed and wherein the formed part consisting of glued or welded plastic foam particles possesses, without the reinforcing elements, a weight per space of 15 to 170 kg/m³.

4. The element for the absorption of energy according to claim 1, wherein several reinforcing elements, upon subjection of the energy absorbing element to compression, buckle in during compression, not all at once but rather at least partially, one after the other.

5. The element for the absorption of energy according to claim 4, wherein the reinforcing elements have different lengths within the element in the direction of compression.

6. The element for the absorption of energy according to claim 1, wherein the reinforcing elements are in the form of a bar or a tube or discs or crosses or Y- or X- or V- or T- or L- or U- or Z-shaped profiles.

7. The element for the absorption of energy according to claim 1, wherein several reinforcing elements are connected to one another via material bridges which possess a solidity at the point where the reinforcing elements are positioned in common in a form for welding or gluing of the plastic foam particles.

8. The element for the absorption of energy according to claim 1, which has a yield factor of 0.65 to 0.95 with respect to a quasi-static measurement.

9. The element for the absorption of energy according to claim 8, which has a yield factor of 0.8 to 0.95 with respect to a quasi-static measurement.

10. A shock absorber which protects against lateral impact or function as an impact deflector element in motor vehicles, prepared from the energy absorbing element according to claim 1.

11. A pallet prepared from energy absorbing element according to claim 1.

12. A method of forming an energy absorbing element, comprising:
placing reinforcing elements within a mold cavity in a position such that the elements extend in the direction of stress which is applied to the product body in its use;
filling the mold cavity with plastic foam particles thereby enveloping the reinforcing elements;
heating the contents of the mold thereby bonding the foam particles to each other to obtain a shaped plastic body.
